(19) United States
(12) Patent Application Publication
(10) Pub. No.: US 2003/0226809 A1
(43) Pub. Date: Dec. 11, 2003

(54) Method and apparatus for determining oil filter life

(75) Inventors: Peter Zagone, Huntington Woods, MI (US); S. Miller Weisman II, Grosse Pointe Park, MI (US); Ann W. Rock, Grosse Pointe Park, MI (US)

Correspondence Address: BROOKS KUSHMAN P.C., 1000 TOWN CENTER, TWENTY-SECOND FLOOR, SOUTHFIELD, MI, 48075, US

(73) Assignee: Detroit Diesel Corporation, Detroit, MI

(21) Appl. No.: 10/164,216

(22) Filed: Jun. 6, 2002

(51) Int. Cl. B01D 35/143

(52) U.S. Cl. 210/741; 210/742; 210/90; 210/85; 210/149

(57) ABSTRACT

An oil circulation system that monitors filter life and can notify the operator of the oil filter life status. The oil filter life is calculated based upon oil pressure sensors on the inlet and outlet of the oil filter. Pressure drop, oil temperature, and engine speed from the tachometer are factored into an algorithm to calculate the percentage of oil filter life remaining. If the percentage is below the predetermined level, the system will warn the operator to change the filter. If the percentage is above the predetermined level, the system will record the extent of oil filter life remaining and repeat the process.

### BACKGROUND OF THE INVENTION

1. Field of the Invention

The present invention relates to a method and apparatus for determining the length of the remaining useful life for an oil filter in an engine.

2. Background Art

Internal combustion engines, including, but not limited to, compression combustion engines, require an oil circulation system to lubricate moving parts such as the pistons, connecting rods, valves, and crankshaft engine bearings. One or more filters are generally provided to remove contaminants from oil as it is circulated through the engine. Oil is normally pumped from an engine oil gallery, through a filter, provided to the distribution system of the engine and is then returned to the engine oil gallery.

Assuring that oil is free from contaminants is important to obtain peak performance and extend engine life. It is important that oil be changed periodically and it is also important to change oil filters when full of contaminants. Engine oil filters that are filled with contaminants will restrict the flow of oil to the engine and reduce the effectiveness of the lubrication system. Many systems having multiple filters include a bypass for bypassing a filter if the pressure drop exceeds a predetermined maximum value. If both of the oil filters in a double filter system are bypassed, engine lubrication is compromised and the engine may be adversely affected. If a filter is bypassed prematurely, filter life is unnecessarily shortened.

The prior art has attempted to address this problem. One example of a prior art solution is disclosed in U.S. Pat. No. 5,968,371 to Verdegan et al. wherein a lubricant filtering and monitoring system is provided for an engine. Sensors are provided before and after passage through a filter and before and after passage through a lubricated component such as an engine. The temperature and viscosity of the lubricant are also sensed. Data from the sensors is used to calculate values for estimated remaining useful life and estimated total useful life of the oil filter. The values are calculated based upon a curve fitting algorithm. The remaining useful life value may be provided to the operator to facilitate scheduling oil filter service. The total useful life value is used to provide an indication of filter life. This data may also be used to automatically initiate a cleaning cycle for the filter. The Verdegan patent fails to account for non-linear factors such as engine speed and as a result may be subject to erroneous reporting regarding the condition of the oil filter. This would be particularly likely to occur when the engine oil temperature is low and the engine is running at a relatively high speed. The Verdegan system also requires a large number of sensors that increase the cost of the system.

The present invention is directed to solving the above problems as summarized below.

### SUMMARY OF THE INVENTION

According to one aspect of the present invention, a method of determining oil filter life comprises providing an oil gallery that supplies oil to an engine and receives oil after it returns from the engine. The temperature of the oil is measured and transmitted as a first signal indicative of oil temperature to an engine controller. The engine speed is measured and a second signal indicative of engine speed is provided to the controller. Oil is filtered in an oil filter after the oil leaves the oil gallery and before the oil is provided to the engine. A first oil pressure is sensed prior to the oil being supplied to the oil filter and a second oil pressure value is sensed after the oil exits the oil filter. The first and second oil pressure values are compared and a sensed differential value is calculated. A value representing the remaining filter life is then calculated based upon the sensed differential value, the oil temperature value, and the engine speed value.

According to another aspect of the invention, an operator is provided with a perceptible signal when the value representing the remaining filter life falls below a predetermined value.

According to other aspects of the invention, the sensed differential signal is not linearly related to the remaining filter life and wherein the remaining filter life is calculated as a linear function by factoring in either or both of the oil temperature signal or engine speed signal.

According to yet other aspects of the invention, the first and second oil pressure values are sensed by at least one differential pressure transducer. The differential pressure transducer may be a spring biased plunger that moves in response to changes in pressure and wherein the position of the plunger is sensed by a hall effect sensor. Alternatively, the differential pressure sensor may be an oil filled capacitive assembly that indicates changes in differential pressure by changing capacitance. The differential pressure sensor may also comprise a pair of sensors that measure oil pressure at the inlet and outlet of an oil filter adapter and that provides two signals that indicate pressure to the engine controller. The engine controller in turn calculates the difference between the sensors to arrive at the differential pressure.

According to another aspect of the invention, the method of determining oil filter flow restrictions in a system having oil circulating through a filter comprises sensing an inlet oil pressure value upstream of the oil filter and sensing an outlet oil pressure value downstream of the oil filter. The differences between the inlet and outlet oil pressures is calculated. The temperature of the oil and engine speed are measured and filter life calculated according to the following algorithm:

maximum pressure drop−measured pressure drop*100*fn(rpm)*fn(temperature)/maximum pressure drop

The invention may also be characterized as a lubrication system and engine combination. The engine includes an engine oil gallery in which an oil temperature sensor is disposed for providing a signal indicative of the temperature

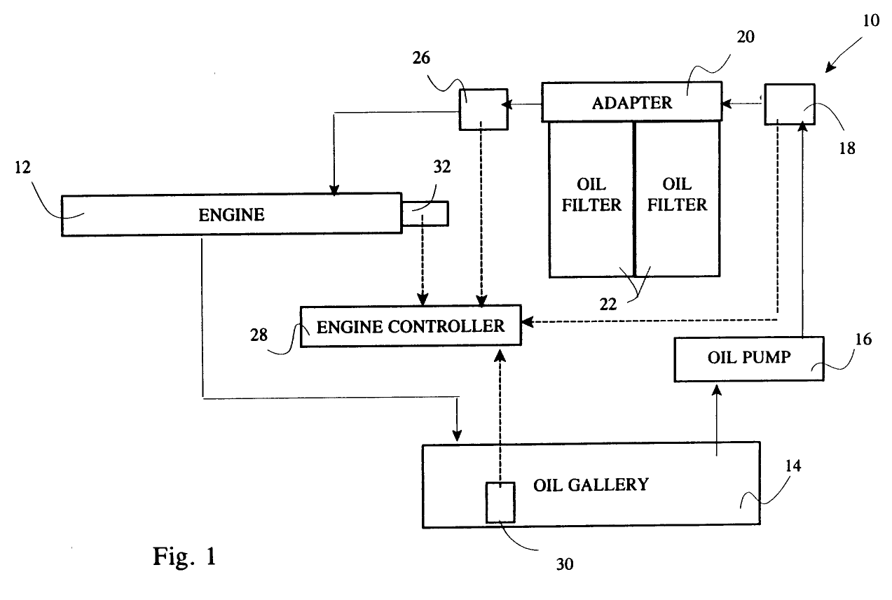

As indicated by the dashed lines in FIG. 1, an engine controller 28 receives signals indicative of the oil pressure from the inlet pressure sensor 18 and the outlet pressure sensor 26. The engine controller also receives a signal indicative of the temperature of the oil in the oil gallery 14 from a temperature sensor 30 that is shown disposed in the oil gallery 14. The temperature sensor 30 could be provided in another location, for example, in the oil adapter, or in an oil supply line, or other location that would expose the temperature sensor to the oil. A tachometer 32 is provided on the engine 12. The tachometer 32 provides an indication of the speed of the engine in revolutions per minute (rpm).

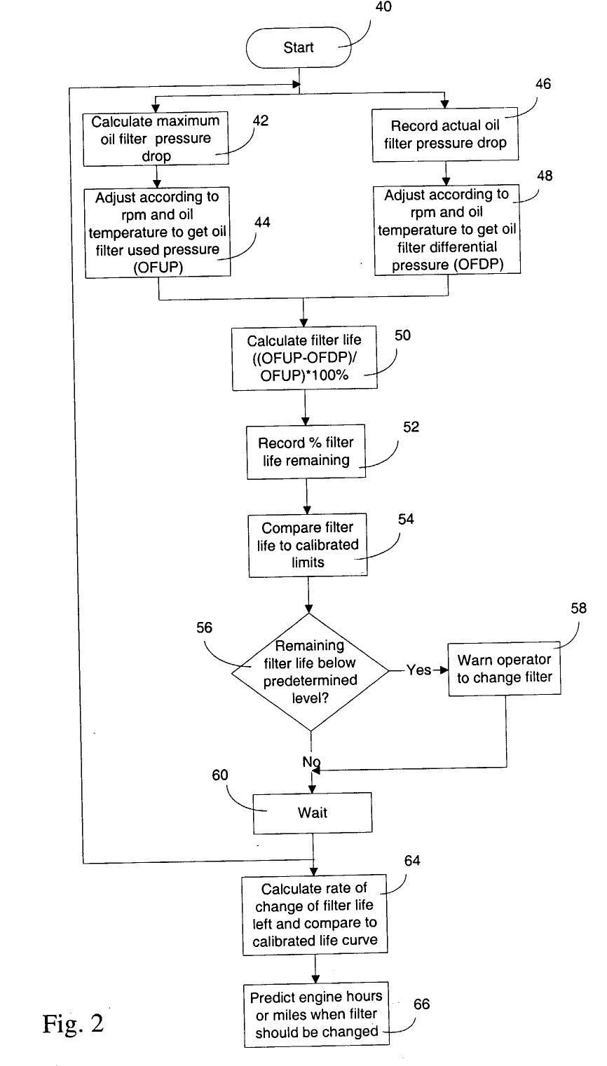

Referring now to FIG. 2, the flowchart of the system for calculating filter life is illustrated schematically. The flowchart begins at start 40. Initially, the system calculates the maximum oil filter pressure drop at 42. The maximum oil filter pressure drop value is then adjusted at 44 according to the rpm, and oil temperature to obtain a value referred to as oil filter used pressure (OFUP). The system records the actual oil filter pressure drop 46 by comparing the pressure readings of the inlet pressure sensor 18 and the outlet pressure sensor 26. The actual oil filter pressure drop measured at 46 is adjusted at 48 according to the rpm and oil temperature signals to obtain the oil filter differential pressure (OFDP). Next, the filter life is calculated by subtracting OFDP from OFUP and dividing it by OFUP, then multiplying that ratio times 100% at 50. This calculation may be performed by the engine controller but could also be performed by a separate control module. After the filter life is calculated at 50, the percent filter life remaining is recorded at 52. The filter life remaining is compared to calibrated limits at 54 and a determination is made at 56 as to whether the remaining filter life is below a predetermined level. If so, the operator is warned at 58 to change the filter. If the filter life remaining is not below the predetermined level at 56, then the system waits a predetermined period of time before reiterating through the cycle. After waiting at 60, the system calculates the rate of change of filter life at 64 and compares it to the calibrated life curve. Then at 66, a prediction is made as to the number of engine hours or miles before the filter should be changed.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of determining oil filter life comprising:
providing an oil gallery that provides oil to an engine and receives oil after it returns from the engine;
measuring the temperature of the oil and transmitting a first signal indicative of oil temperature to an engine controller;
measuring the engine speed and providing a second signal indicative of engine speed to the engine controller;
filtering oil in an oil filter after the oil leaves the oil gallery and before the oil is provided to the engine;
sensing a first oil pressure value as the oil is supplied to the oil filter and a second oil pressure value as the oil exits the oil filter
comparing the first and second oil pressure values and calculating a sensed differential value; and
calculating a value representing the remaining filter life based upon the sensed differential value, the first signal and the second signal.

2. The method of claim 1 further comprising providing an operator perceptible signal when the value representing the remaining filter life is below a predetermined level.

3. The method of claim 1 wherein the first signal is not linearly related to remaining filter life and wherein the remaining filter life is converted into a linear function after the first signal is factored into the calculation.

4. The method of claim 1 wherein the second signal is not linearly related to remaining filter life and wherein the remaining filter life is calculated as a linear function after the second signal is factored into the calculation.

5. The method of claim 1 the first and second oil pressure values are sensed by at least one differential pressure transducer.

6. The method of claim 5 wherein the differential pressure sensor is a spring biased plunger that moves in response to changes in pressure and wherein the position of the plunger is sensed by a hall effect sensor.

7. The method of claim 5 wherein the differential pressure sensor is an oil filled capacitive assembly that senses changes in differential pressure by changing capacitance.

8. The method of claim 5 wherein the differential pressure sensor is a pair of sensors that measure oil pressure at the inlet and outlet of the oil filter adapter and provides two signals that indicate pressure to the engine controller that calculates the difference between the sensors as the differential pressure.

9. A method of determining oil filter flow restriction in a system having oil circulating through a filter comprising:
sensing an inlet oil pressure value upstream of the oil filter;
sensing an outlet oil pressure value downstream of the oil filter;
calculating the difference between the inlet oil pressure value and the outlet oil pressure value;
measuring the temperature of the oil;
measuring the engine speed;
calculating filter life by the following algorithm
maximum pressure drop−measured pressure drop*100*fn(rpm)*fn (temperature)/maximum pressure drop.

10. A lubrication system and an engine in combination, comprising:
an engine oil gallery;
an oil temperature sensor for providing a signal indicative of the temperature of oil in the system;
an engine speed sensor for providing a signal indicative of the engine speed;
an oil filter secured to the engine by an oil filter adapter;
at least one sensor for determining the pressure differential of oil flowing into and out of the oil filter and providing a value representative of the measured pressure drop; and
a controller for calculating oil filter life by comparing the measured pressure drop value to a maximum pressure drop value after adjusting each pressure drop value based upon the signal indicative of temperature of the oil and the signal indicative of the engine speed.

11. The combination of claim 10, wherein the differential pressure sensor is a spring biased plunger that moves in response to changes in pressure and wherein the position of the plunger is sensed by a hall effect sensor.

12. The combination of claim 10, wherein the differential pressure sensor is an oil filled capacitive assembly that senses changes in differential pressure by changing capacitance.

13. The combination of claim 10, wherein the differential pressure sensor is a pair of sensors that measure oil pressure at the inlet and outlet of the oil filter adapter and provides two signals that indicate pressure to the engine controller that calculates the difference between the sensors as the differential pressure.

14. The combination of claim 10, further comprising providing an operator perceptible signal when the value representing the remaining filter life is below a predetermined level.
